(19) United States
(12) Patent Application Publication
(10) Pub. No.: US 2002/0143816 A1
(43) Pub. Date: Oct. 3, 2002

(54) Method and system for using a generalized execution engine to transform a document written in a markup-based declarative template language into specified output formats

(76) Inventors: Michael P. Geiger, Palo Alto, CA (US); William J. Laubenheimer, Sunnyvale, CA (US)

Correspondence Address: Percarrence, Inc., 630 Barnsley Way, Sunnyvale, CA, 94087, US

(21) Appl. No.: 09/800,436

(22) Filed: Mar. 6, 2001

(51) Int. Cl. G06F 15/00

(52) U.S. Cl. 707/513

(57) ABSTRACT

A method and system for describing information within a structured document, such as an XML document. A declarative description that describes both the location and the format and structure of the information is included in the structured document. This declarative description can be subsequently employed by a transformation engine to extract and transform described information according to a transformation specification.

### TECHNICAL FIELD

The present invention relates to the fields of computer languages and data representation and, in particular to the use of a generalized execution engine to transform a declaratively represented document template expressed in a descriptive markup language into one or more output documents that can be displayed in a web browser, provided to various application programs as input, or otherwise used for various computational tasks.

### BACKGROUND OF THE INVENTION

Historically, the term “markup” referred to the process by which a copy editor marked up a manuscript with typesetting directions. By analogy, the term “electronic markup” was used to describe codes or tags that were embedded in a computer file to specify how it should be formatted when printed on paper or displayed on a screen. Descriptive markup languages were later devised to represent the logical structure of a document independently of any formatting instructions. A document represented in a descriptive markup language can subsequently be rendered in many different ways by applying different sets of formatting instructions, also known as “style sheets ”. These ideas are most notably implemented in the Standard Generalized Markup Language (“SGML”), which has been used successfully since the 1980s to manage the publication of complex technical documents such as aircraft maintenance manuals. SGML is actually a means of creating customized markup languages, each of which reflects a particular set of semantics. These semantics are specified in a Document Type Definition (“DTD”), which defines a customized set of element tags and associated attributes.

The Hypertext Markup Language (“HTML”), in which most World Wide Web pages are written, is defined by an SGML DTD. Thus, HTML provides a fixed set of markup tags that web browsers interpret to produce a variety of behaviors. One of the most important features of HTML is its support for hyperlinks, which permit end users to display related information by clicking on text or a graphic displayed via a user interface or a display device.

Despite its success, HTML suffers from important limitations arising from providing only a fixed set of markup tags. The World Wide Web Consortium (W3C) consequently embarked on an effort to create a new language that has SGML's power to create customized markup languages, but that eliminates many of SGML's more complex features. The result of this effort is the Extensible Markup Language (“XML”)

Many in the computer industry consider XML to be an important next step in the evolution of the Internet. XML can represent data in ways that can easily be understood by both human beings and computer programs. In XML, as in SGML, a piece of text can be surrounded by a pair of customized element tags that describe the meaning of the text that they enclose. For example, a person's name can be represented in XML as “<name> John Doe</name>.” Like SGML, XML uses a DTD to represent a particular set of semantics. In XML, the optional DTD specifies a set of customized element tags and associated attributes, which are typically used to supply important supplementary information, such as the location of multimedia content. A DTD can specify how element tags can be nested within one another, thereby making it possible to create complex, hierarchical data structures.

An XML document is said to be valid if it complies with constraints, set forth in a DTD, that constitute a vocabulary for representing certain kinds of information. Ambiguity can result if different DTDs use the same tag names to represent different meanings. For example, one DTD might define a tag “name” as referring to the name of a customer, while another DTD might define a tag “name” as referring to the name of a botanical species. An XML Namespaces proposal provides a means of resolving conflicts among DTDs that use identical tag names to represent different meanings.

The flexible design of XML allows XML syntax to be equally useful for representing both documents and messages. Traditionally, a document has been viewed as a lengthy, complex amalgam of information primarily intended for human readers. On the other hand, a message has typically been viewed as a short, relatively simple piece of structured information intended to be passed between computer systems, without necessarily ever being seen by humans. Although this distinction is often useful, XML documents and messages can both be regarded as data represented in XML syntax.

Declarative computer languages define relationships that specify what a program is supposed to compute, without saying how the computational task should be accomplished. In contrast, imperative languages specify step-by-step sequences of operations the program performs. Languages can be placed along a spectrum that ranges from purely imperative to purely declarative, and a particular language may have some aspects that are declarative and others that are imperative. Declarative features arguably make a language easier for people without extensive programming experience to use.

The capabilities of template languages make it possible to search a target document for specified characteristics or patterns, to identify the features that match these patterns, and to specify how the identified features should be transformed. When a template is applied to a target document, recognized features within the target document are transformed. A template is analogous to a stencil. Just as different art works that share the same design can be produced by applying paints of different colors and textures to a single stencil, different data representations that share a common structure can be produced by applying a single template to different target documents. The ability to perform substitution operations is a hallmark of template languages. These operations generate output in which features recognized in the target document, i.e., features that match a pattern specified in the template, are replaced with different data.

FIG. 1 illustrates one of many ways to categorize computer languages. The vertical axis 100 in the figure represents the spectrum from purely imperative to purely declarative. A plane 101 is divided into four regions to indicate whether a language has template capabilities and whether it is based on XML, the four regions including: (1) a first region 102 that contains XML-based languages with template capabilities; (2) a second region 103 that contains languages that are dialects of XML but have no template capabilities; (3) a third region 104 that contains languages which have no template capabilities and that are not based on XML; and (4) a fourth region 105 that contains XML-based languages having no template capabilities. The plane 101 can be moved up or down the vertical axis 100 to indicate where the languages in the plane fall on the spectrum between purely declarative and fully imperative.

Some of the most well known programming languages 106 are entirely imperative, are not based on XML, and do not have template capabilities. These languages include C/C++, Java, Pascal, Cobol, and Fortran. The Perl and awk languages 107 have template capabilities, with both declarative and imperative features. These languages employ regular expressions to recognize patterns in input text, and to then perform substitutions, or other operations, on matching text. Extensible Style Sheet Language Transformation (XSLT) 108 is an XML-based template language having both declarative and imperative characteristics. Prolog and SQL 109 are examples of declarative languages that do not have template capabilities and are not based on XML. An SQL SELECT statement is declarative because it specifies the data for a query to retrieve, without telling the database management system how it should go about accessing the information.

Internet developers, application developers, and other computer industry workers have recognized a need for an XML-based language with both declarative features and powerful template capabilities. Such a language, if developed, would inhabit a position 110 within the categorization scheme shown in FIG. 1.

### SUMMARY OF THE INVENTION

The present invention combines a markup-based declarative template language with a generalized execution engine. The declarative template language is defined in terms of an XML DTD or schema, and an XML document satisfying these constraints acts as a program that directs the behavior of the generalized execution engine. The output produced by the execution engine is a transformation of the XML input document, which can direct the engine to produce output in a variety of formats including XML, HTML, and plain text. An XML document expressed in the template language will be equivalently interpreted by any computing environment that can run the execution engine.

Such a system empowers the author of an input document to use XML as a programming language as well as a markup language. For example, the author can employ constructs in the declarative template language that cause the execution engine to connect to a data source, iterate through a set of data returned by specified selection criteria, such as an SQL query or an XPath expression, and write transformed output to a specified file.

### BRIEF DESCRIPTION OF THE DRAWINGS

FIG. 1 illustrates characterization of a computer language as declarative, template-based, XML-based, or as fitting into more than one of these categories.

FIG. 2 summarizes processing, by a generalized execution engine, of an input document template to produce transformed output.

FIG. 3A illustrates processing, by a typical template language, of input data files, and FIG. 3B illustrates advantages of direct communication with underlying data sources.

FIG. 4A illustrates that mapping disparate data models to a common data model is usually a prerequisite for further processing.

FIG. 4B shows elimination, by a data connectivity layer, of the need for this task.

FIG. 5 illustrates the architecture of a document transformation system.

FIG. 6 illustrates template patterns that are recognized by a document transformation engine.

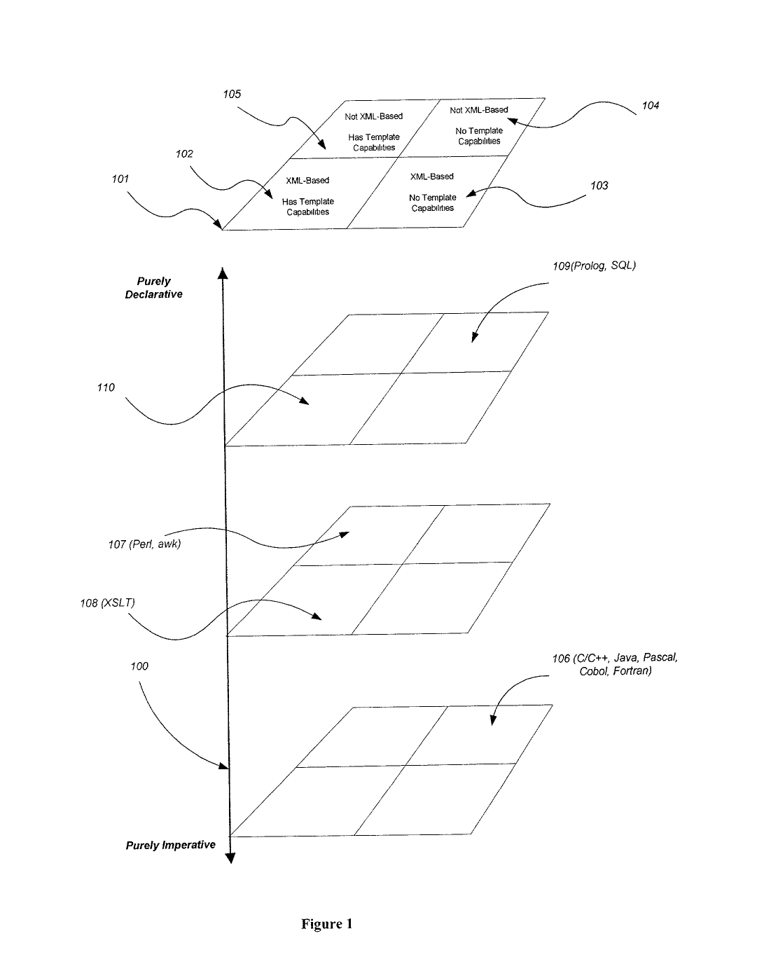

### DETAILED DESCRIPTION OF THE INVENTION

Embodiments of the present invention provide an XML-based declarative template language and a generalized execution engine for processing documents expressed in the template language. The execution engine connects with underlying data sources so that it can substitute retrieved data values into the appropriate holes or slots within a template document. Different embodiments typically have different XML-based declarative template languages and different implementations of the generalized execution engine. For example, one embodiment uses a particular DTD to define a declarative template language with a given set of features. The generalized execution engine that processes input documents in this particular template language may be written in C++. A different embodiment uses a different DTD to define another template language with a different set of features, and the generalized execution engine for this template language may be written in Java. The two embodiments may access different kinds of underlying data sources, may use different syntaxes for invoking substitutions, and may be deployed in different computing environments.

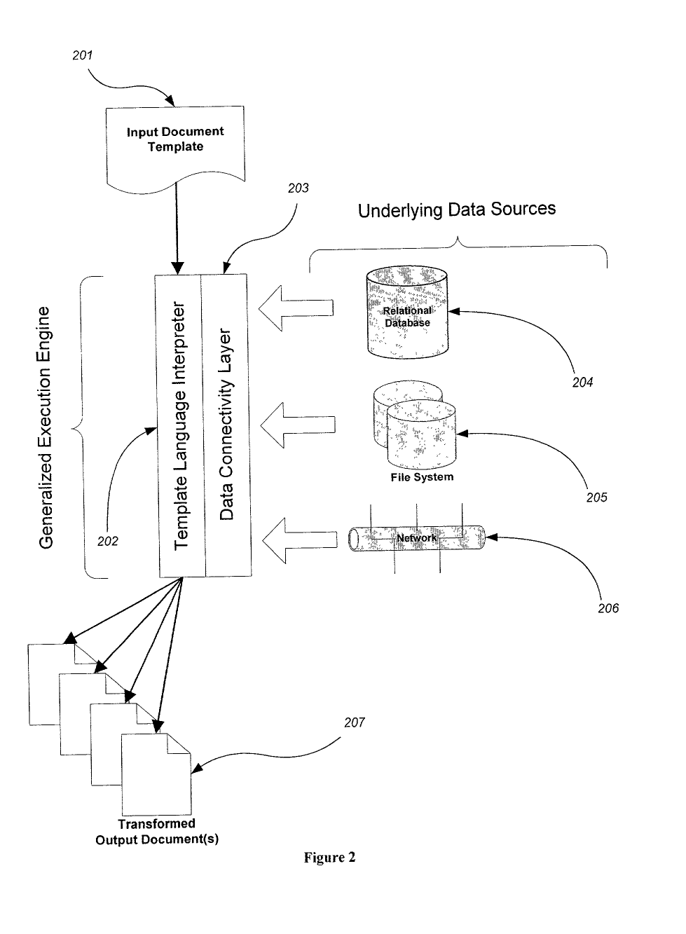

FIG. 2 illustrates the essential features of the invention. The generalized execution engine consists of a template language interpreter 202 and a data connectivity layer 203. The input 201 to the template language interpreter is an XML document complying with the constraints of the declarative template language. As it processes the input document, the language interpreter invokes the data connectivity layer so that it can access the underlying data sources that are identified in the input document. Examples of such data sources include relational databases 204, file systems 205, and remote resources available across a network 206. In a substitution process, the language interpreter then replaces template language expressions in the input document with data retrieved from the underlying data sources. Output corresponding to different parts of the input document template can be directed to different files, resulting in one or more transformed output documents 207.

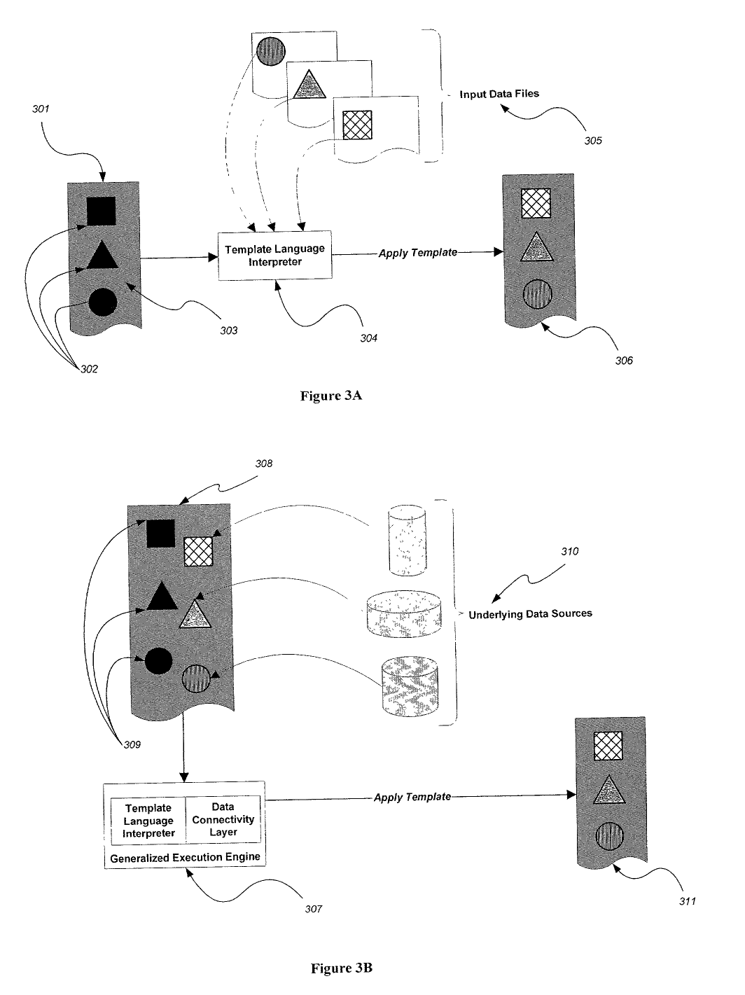

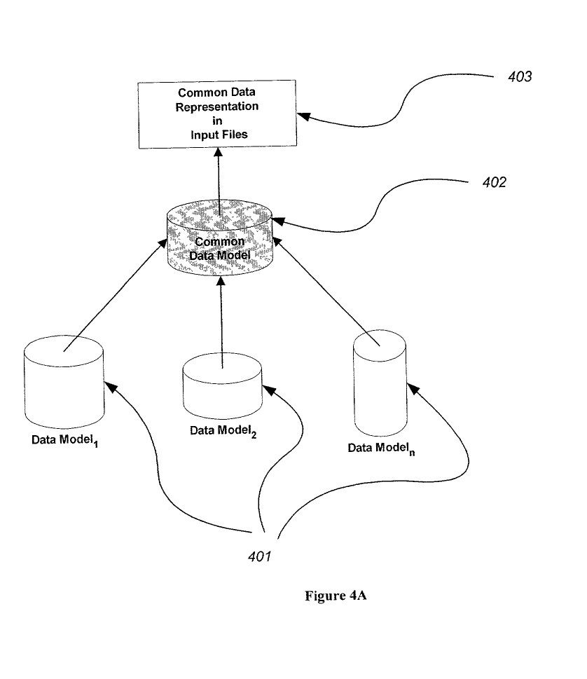

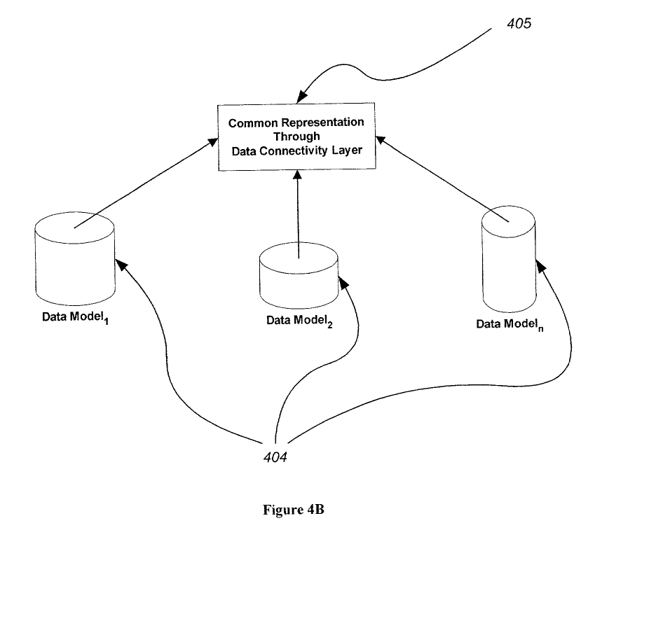

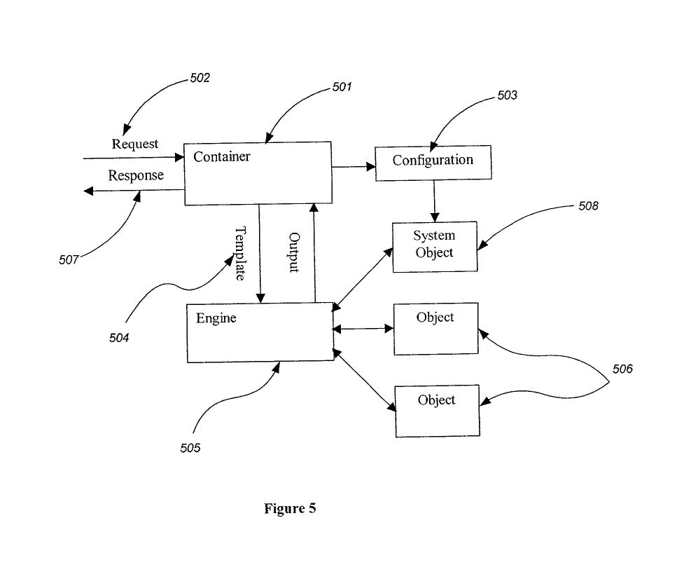

The system illustrated in FIG. 2 derives much of its functionality from three design characteristics that work together in an innovative manner. First, the pattern recognition and feature extraction mechanisms of the template language rely on the structure of XML. As opposed to using Perl-like regular expressions to recognize patterns in text, the system uses an XML parser to recognize features of interest in the XML input document. Second, the system differs from a conventional template language in how templates are applied. These differences are diagrammed in FIGS. 3A and 3B. The third design characteristic of note is a high degree of data model independence, as illustrated in FIGS. 4A and 4B.

In FIG. 3A, a template 301 is represented as a set of holes or slots 302 within a framework 305. These holes are depicted as different shapes, e.g., a square 304, a triangle, and a circle 302), in an effort to indicate they can be filled only by data that matches the corresponding shape. In a conventional template language, the template 301 is a program executed by a template language interpreter 306. When the interpreter runs the program, it searches input files 307 for data matching the holes in the template. The input files may be identified in the template or on the command line that invokes the interpreter. After the template has been applied, the result 308 is a document in which the holes in the template have been filled with matching data from the input files.

With a conventional template language, it is often necessary to construct the input files from a variety of underlying data sources, such as relational databases or object-oriented document repositories, before a template can be applied. Because it communicates directly with underlying data sources, the data connectivity layer of the present invention obviates the need to create and process input data files. In FIG. 3B, the generalized execution engine 309 invokes the data connectivity layer as it processes XML-based declarative statements in the template 310. The data connectivity layer then fills the holes 311-313 in the template by communicating directly with the underlying data sources 314. The result 315 is the same as in FIG. 3A, but the holes in the template have been filled in a more efficient manner.

The data connectivity layer of the present invention permits more data model independence than conventional template languages do. As shown in FIG. 4A, disparate data models 401 typically must be mapped to a common data model 402 and a common data representation 403 so that a program can understand the data in its input files. FIG. 4B illustrates that the data connectivity layer provides abstractions of different data models 404 and that the XML-based declarative template language serves as a unified representation 405 for these abstractions.

The embodiment described below is a document transformation system consisting of: (1) a transformation engine, which processes declarative templates and generates the output described by the templates; (2) a number of objects, which implement models of data sources and destinations; and (3) a container, which manages the process of presenting declarative templates to the transformation engine and directs output generation.

As illustrated in FIG. 5, the container 501 receives an information request 502 from a requester. The container logic defines a configuration 503 and passes 504 a template to the engine 505 for interpretation. When the engine recognizes a template pattern for interaction with an object 506, the interaction takes place and the results are substituted for the recognized portion of the template. The portions of the template that do not take part in an interaction are combined with the results of the interactions to produce the output from the engine. The container logic uses the request, configuration and output to create 507 a response.

An object describes a model of data outside the engine. The engine can assign a name to external data to be viewed or manipulated through the model in a process referred to as “instantiation.” The result of instantiation is an instance of the object. The instance is identified by the name assigned by the engine.

The engine can make requests to exchange data with an instance. Some requests send data from the instance to the engine, while other requests send data from the engine to the instance. The object determines the mapping between the internal data model associated with the object and the external structure of the associated data.

The PerXML Smart Messaging System is a realization of this document transformation system using software programs as the mechanism, and comprises the PerXML Transformation Engine, the PerXML Standalone Program, PerXML COM Component, PerXML IIS Module, and nine PerXML objects.

The PerXML Transformation Engine is a realization of the engine using XML as the template language. The PerXML Standalone Program, PerXML COM Component and PerXML IIS Module are realizations of the container as a standalone executable program, a component conforming to the Component Object Model standard, and a component that can be invoked from the Microsoft Internet Information Server. The PerXML System Object is a realization of the system object 508 of FIG. 5, which is responsible for configuring the transformation engine. The other types of PerXML objects and the data that they model are listed below in

TABLE 1

| PerXML Object | Data Modeled by the PerXML Object |
|---|---|
| String Object | Textual input data |
| XML Object | XML input data |
| Script Object | Script source code |
| SQL Object | A relational database capable of accepting |
| | commands in Structured Query Language |
| | (SQL) |
| Repository Object | An object repository |
| Extension Object | Custom logic invoked by an invocation |
| | protocol |
| Remote Object | Custom logic invoked by a text messaging |
| | protocol |
| Writer Object | Textual output data |

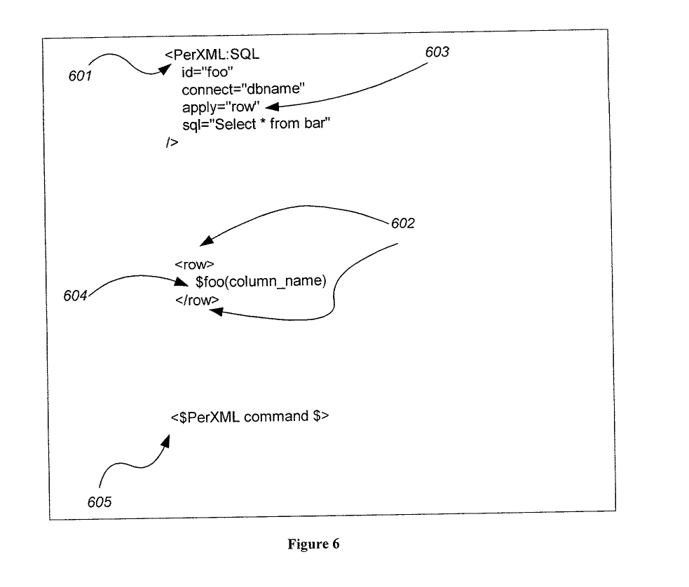

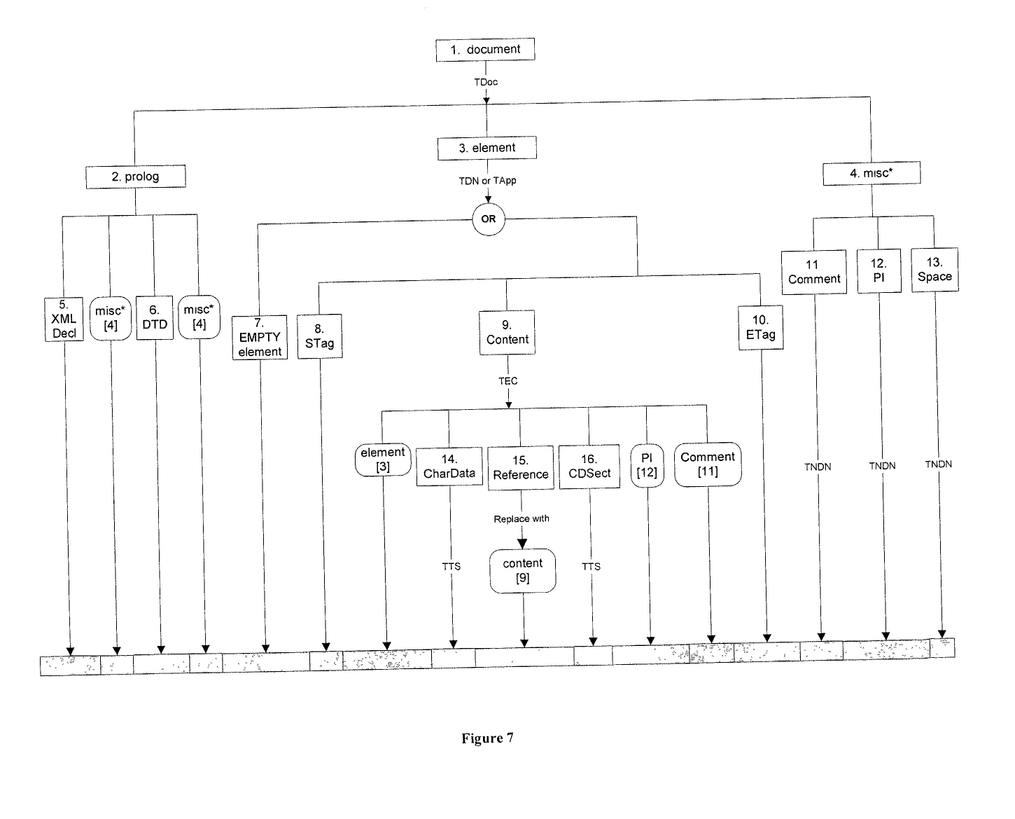

The PerXML Transformation Engine recognizes four different template patterns, as illustrated in FIG. 6 in the case where the template language is a dialect of XML. Descriptions of the information extracted from the template patterns, and how the information modifies the state of the PerXML transformation engine, are presented below.

An instance definition pattern is recognized by the appearance in the template of one of the distinguished PerXML element tags 601. The element attributes and contents define the instance configuration and designate the resource the instance is to model, as described in the section entitled “Descriptions of Object Behavior.”

An instance application pattern is recognized by the appearance in the template of an element tag 602 declared as an application tag 603 in an instance definition. The element tag and its contents define a section of the template to be transformed by the rules of the controlling instances.

A substitution pattern is recognized by the appearance of a distinguished substitution character 604 in the template, followed by text matching one of the defined PerXML substitution patterns. The matching text defines an instance and indicates an action to be taken by the instance.

A configuration-setting pattern is recognized by the appearance in the template of a processing instruction 605 with a target of PerXML. Certain configuration options can be controlled by specifying the option the value to which it is to be set.

The PerXML Standalone Program accepts execution parameters that specify a template, an output location, and configuration parameters. The configuration parameters are combined with configuration information drawn from an initialization file to define the engine configuration. The template is presented to the PerXML Transformation Engine, and the engine output is placed in the specified output location.

The PerXML COM Component provides a COM interface that allows a COM client to specify a template and certain configuration parameters. The configuration parameters are combined with configuration information drawn from an initialization file to define the engine configuration. The template is presented to the PerXML Transformation Engine, and an interface method to retrieve the output is provided.

The PerXML IIS Module provides a module conforming to the Microsoft Internet Information Server module API. The module is triggered by an incoming request to a system running the IIS core. Configuration information drawn from an initialization file determines how the request is processed to provide a template and engine configuration; this information is combined with more information from the initialization file to define the engine configuration. The template is presented to the PerXML Transformation Engine, and the engine output is returned as the response to the request.

The PerXML Transformation Engine implements a process by which an initial engine state Stₒ is transformed into a final engine state St* as template patterns in an input template T are recognized and processed by the engine. The final state holds the information required by the container. FIG. 7 illustrates how an XML document can be used as the template source language and be transformed using the algorithms described.

The PerXML Transformation Engine processes text from an input template until the text has been completely processed or a template pattern is recognized. When a template pattern is encountered in the input template, the PerXML Transformation Engine incorporates the non-pattern text into the current engine state and then extracts certain information from the template pattern and passes that information, along with the current engine state, to a process associated with the template pattern. That process uses functions defined by certain object types to compute a new state which then becomes the current engine state. Template processing is then repeated until the entire input template has been processed.

### The Transformation Engine State

The transformation engine state is a tuple containing elements from a number of different sets. The set of characters, Char, is defined by the container. The elements represent character symbols as might appear in a document or message passed to or from the container.

The set of external values, ExtVal, is defined by the extension object. The elements represent instances of component objects that may be passed to other component objects modeled by instances of the extension object. The set of character strings, Str, is defined as:

Str={(n, f):nεN, f:N→Char}

The nonnegative number n represents the length of the string, and the function ƒ represents the content of the string. The elements represent sequences of characters.

Particular subsets of Str of interest to the transformation are:

FN, the set of properly constructed filenames. This set is defined by the container.

Name, the set of valid object names. This set is a characteristic of the template language; when XML is the template language, Name consists of any string valid as a markup tag.

A frequently used string operation, concatenation, is defined for two strings s₁=(n₁, ƒ₁) and s₂=(s₂, ƒ₂) by:

s₁+s₂=(n₁+n₂, f₁∪{(i₂+n₁, c₂):(i₂, c₂)εf₂})

The set of files, Files, is defined as:

Files {f:FN→Str}

The filename represents the name of the file, and the string represents its contents.

The set of configurations, Conf, is defined as:

Conf={f:Name→Str}

The name represents the name of the configuration element, and the string represents its value. The set of argument values, Val, is defined as:

Val=Str∪ExtVal

An argument value represents something that can be passed to an object instance. The set of argument lists, Args, is defined as:

Args={(ac, f):acεN, f:N→Val}

The nonnegative number ac represents the number of arguments in the list, and the function ƒ represents the complete list of arguments. A function for generating elements of Args of interest to the transformation is the choice function:

Ch:Val×Val→Args

defined by:

Ch(v1, v2)=(2, (0, v1), (1, v2)

The set of method implementations, MethImpl, is defined as:

MethImpl={f:Args×Conf×Val→Val}

The argument list represents information from a substitution; the configuration represents information about an instance identified in the substitution and the value argument represents information about the instance application controlling the instance. The return value represents the result of applying the function represented by the method implementation in the context represented by the configuration and value arguments. The set of method tables, Meth, is defined as:

Meth={f:Name→MethImpl}

The function maps a method name such as might appear in a substitution pattern to a method implementation. The set of object instances, Inst, is defined as:

Inst={(cn, C, b, val, sc, ic):cnεName, CεConf, bεStr, valεArgs, scεN, icεN}

The name cn is the name of the object type that specifies the behavior of the instance. The configuration C represents the characteristics of this instance. The body b represents the content of the portion of the template that caused the instance to be generated. The argument list val represents a sequence of values that are passed to method implementations invoked within an instance application. The nonnegative number sc represents the number of instance application patterns enclosing any such pattern to which this instance applies. The nonnegative number ic represents the number of times the instance application pattern associated with this instance has been processed. The set of instance tables, Var, is defined as:

Var={f:Name→Inst}

The name represents the string by which the instance is referenced in a substitution. The object instance defines the behavior of the instance. The set of states, St, is defined as:

St={(C, t, F, sl, V, A):CεConf, tεStr, FεFiles, slεN, VεVar, A⊂Name}

The configuration C represents object and recognizer capabilities. The transformed document t represents the transformed form of the portion of the input template processed by the engine. The file table F represents files that have been generated by the engine as a result of processing the currently processed portion of the input template. The scope level sl represents the number of currently active instance applications. The instance table V represents the object instances that have been created by the engine as a result of processing the currently processed portion of the input template. The apply tag set A represents the set of names identifying instance application patterns.

### Object Types

An object type is represented as a collection of functions, associated with an object type name, that are invoked by the PerXML Transformation Engine during template processing. The values returned by these functions provide access to, and control over, object behavior while a template is being processed. The set of value generators, VG, is defined as:

VG{f:Conf×Str→Args}

The configuration and string provide the configuration and body of an object instance, and the resulting argument list becomes the value list of the instance. The accessor function generator a:Name→MethImpl generates a function used when a reference to an object instance in a substitution does not specify a method name. The method table generator m:Name→Meth generates a method table used when a reference to an object instance in a substitution specifies a method name. The initializer generator vg:Name→VG generates an initialization function used when an object instance participates in an instance application.

### Object Behavior

Object behavior is defined in terms of a data model provided for the defined PerXML object types. The extension, remote, repository, script and sql objects use an external data model provided by the container, while the system, str, writer and XML objects use an internal data model implemented by the transformation engine. The realization of the transformation engine used in the PerXML Smart Transformation System provides the following definitions. The extension object models an object interface to a software component. The external model defines:

An instantiation method, which creates an identifiable instance of the object represented by the interface;

A set of property accessor functions, which retrieve values from instances of the object represented by the interface;

A set of property setter functions, which change specific state elements of the object represented by the interface;

A set of methods, which implement object behavior represented by the interface.

The system object models the configuration of the transformation engine. The internal model defines these elements of vgPerXML =vg(“PerXML:PerXML”). The remote object models a text interface to an independently executable program. The external model uses container services to give identity to the program, and defines:

A program invocation method, which sends text data as input to the program and receives the text data returned as output from the program;

A result cache, which holds the output received from the last invocation of the program. If the program has not yet been invoked, the result cache holds the empty string ″″.

Given a remote instance definition created by the sample code block:

<PerXML:remote id=“soapdemo” apply=“wash”>

<connect resource=“http://www.soaptoolkit.com/soapdemo/services.asp”

contenttype=“soap/http”/>

<value><![CDATA[<?xml version=“1.0”?>

<SOAP:Envelope xmlns:SOAP=“http://schemas.xmlsoap.org/soap/envelope/”

SOAP:encodingStyle=“http://schemas.xmlsoap.org/soap/encoding/”>

<SOAP:Body>

<GetServerTime></GetServerTime>

</SOAP:Body>

</SOAP:Envelope>]]></value>

<value><![CDATA[<?xml version=“1.0” ?>

<SOAP:Envelope xmlns:SOAP=“http://schemas.xmlsoap.org/soap/envelope/”

SOAP:encodingStyle=“http://schemas.xmlsoap.org/soap/encoding/”>

<SOAP:Body>

<GetUTCTime></GetUTCTime>

</SOAP:Body>

</SOAP:Envelope>]]></value>

</PerXML:remote>

The element definition tuple (ot, conf, b) has:

ot=“PerXML:remote”

conf(“id”)=“soapdemo”

conf(“apply”)=“wash”

b=“<connect resource=“http://www.soaptoolkit.com/soapdemo/services.asp ”

contenttype=“soap/http”/>

<value><![CDATA[<?xml version=“1.0”?>

<SOAP:Envelope xmlns:SOAP=“http://schemas.xmlsoap.org/soap/envelope/”

SOAP:encodingStyle=“http://schemas.xmlsoap.org/soap/encoding/”>

<SOAP:Body>

<GetServerTime></GetServerTime>

</SOAP:Body>

</SOAP:Envelope>]]></value>

<value><![CDATA[<?xml version=“1.0”?>

<SOAP:Envelope xmlns:SOAP=“http://schemas.xmlsoap.org/soap/envelope/”

SOAP:encodingStyle=“http://schemas.xmlsoap.org/soap/encoding/”>

SOAP:Body>

<GetUTCTime></GetUTCTime>

</SOAP:Body>

</SOAP:Envelope>]]></value>”

The invocation method associated with the instance created by the code block executes the following steps when passed an input string S:

1. Build an HTTP message with a standard header for content type “soap/http” and the body S.

2. Send the HTTP message to the URL http://www.soaptoolkit.com/soapdemo/services.asp

3. Place the body of the response in the result cache.

The sample remote instance created by the code block constructs these definitions of vgRem vg(“PerXML:remote”), aRem=α(“PerXML:remote”) and mRem=m(“PerXML:remote”):

[vgRem(C, b)](0)=“<?xml version=“1.0”?>

<SOAP:Envelope xmlns:SOAP=“http://schemas.xmlsoap.org/soap/envelope/”

SOAP:encodingStyle=“http://schemas.xmlsoap.org/soap/encoding/”>

<SOAP:Body>

<GetServerTime></GetServerTime>

</SOAP:Body>

</SOAP:Envelope>”

[vgRem(C, b)](1)=“<?xml version=”1.0”?>

<SOAP:Envelope xmlns:SOAP=“http://schemas.xmlsoap.org/soap/envelope/”

SOAP:encodingStyle=” http://schemas.xmlsoap.org/soap/encoding/“>

<SOAP:Body>

<GetUTCTime></GetUTCTime>

</SOAP:Body>

</SOAP:Envelope”)}

aRem(args, C, val )=″″

[mRem(“Exec”)]((n, args), C, val) executes the external model's invocation method with S=args(0) if n>0.

[mRem(“Run”)]((0, { }), C, val) executes the external model's invocation method with S=val.

[mRem(“Response”)]((0, { }), C, val) returns the contents of the external model's result cache.

The repository object models a repository of objects. The script object models a script engine. The SQL object models a relational database. The external model has access to an implementation of the Open Database Connectivity (ODBC) API, and defines:

A connection method, which establishes a connection to a database by its name, using userid and password credentials;

A cursor generation method, which runs a SQL query against the currently connected database and returns a SQL cursor;

A query execution method, which runs a SQL query against the currently connected database;

A row generation method, which returns an external value representing a specific row of a cursor;

A field access method, which computes a string value given an external value representing a row of a cursor and the name of a field represented in the cursor;

A row access method, which returns a set of tuples (name, value ) ε Str×Str representing all the field names and values given an external value representing a row of a cursor;

A currently connected database;

A current cursor.

Given a SQL instance definition created by the following code block:

<PerXML:sql id=“presdb” apply=“presfromdb” connect=“presidents”

visible=“false”

sql=“select * from president where firstname like “William”/>

The element definition tuple (ot, conf b) has:

ot=“PerXML:sql”

conf(“id”)=“presdb”

conf(“apply”)=“presfromdb”

conf(“connect”)=“presidents”

conf(“uid”)=″″

conf(“pw”)=″″

conf(“sql”)=″select * from president where firstname like “William”

b=. . .

The sample SQL instance created by the code block constructs these definitions of vgSql vg(“PerXML:sql”), αSql=α(“PerXML:sql”), and mSql−m(“PerXML:sql”) vgSql(C, b) constructs its return value by use of the external model in the following steps:

1. Connect the external model to the database C(“connect”), using userid C(“uid”) and password C(“pw”).

2. Construct the external model's current cursor by running the external model's cursor generation method on the SQL query C(“sql”). If the query fails, or there is no currently connected database, the current cursor becomes a default cursor with no rows.

3. vgSql(C, b)=(n, {(i, [vgSql(C, b)](i)) :0<i <n)}), where n is the number of rows retrieved from the database by the query in step 2, and [vgSql(C, b)](i) is an external value representing the ith row of the external model's current cursor.

aSql((n, args), C, val) returns the empty string″″ unless n>0 and args(0) matches a column name in the external model's cursor. In this case, aSql((n, args), C, val) uses the external model's field access method to retrieve the field named by args(0) from the external value val.

[mSql(“Exec”)]((n, args), C, val) runs the extermal model's query execution method on the SQL query args(0) if n>0. The current cursor is not affected.

[mSql(“Run”)](args, C, val) resets the extermal model's current cursor to the result of running the external model's cursor generation method on the SQL query

C(“sql”). This has the additional effect of redefining the values generated by vgsql.

[mSql(“XML”)]((0, args), C, val) performs the following steps:

1. Compute the set RV by applying the external model's row access method to val.

2. Set rs to the empty string″″.

3. For each (name, value) εRV in turn, concatenate “<”, name, “>”, value, “<”, name, “>” to rs.

4. Return rs as the value of [mSql(“XML”)]((0, args), C, val).

[mSql(“XML” )]((n >0, args), C, val) performs the following steps:

1. Apply the external model's field access method to retrieve fv, the field named by args(0) from the external value val.

2. Concatentate “<”, args(0), “>”, fv, “</”, args(0), “>” and return the resulting string as the value of [mSql(“XML”)]((n, args), C, val).

The string object models sequences of characters drawn from the source document or external files or internet objects. The writer object models an external file or internet object. The XML object models XML documents or fragments.

### Template Processing

When configured with a current state St=(C, t, F, sl, V, A) and a current template T=(T.n, T.ƒ), the PerXML Transformation Engine performs the following computation:

1. Attempt to express T=T₁+T₂+T₃, where T₁=(T₁.n, T₁.f) and T₁.n>0, T₂ matches one of the template patterns, and no such partition with a smaller T₁.n can be found.

2. If such a partition exists:

a. Apply the processing step associated with the matched template pattern to the state (C, t+T₁, F, sl, V, A) to produce a state St′.

b. The final state is obtained by configuring the PerXML Transformation Engine with the current state being St′ and processing the template T₃.

1. If no such partition exists, the final state is (C, t+T, F, sl, V, A).

### An Instance of Definition Processing

When the PerXML Transformation Engine recognizes an instance definition pattern p, it produces an element definition tuple (ot, conf, b) εName×Conf×Str. The object type ot is used to identify the type of instance to be created, the configuration conf defines at least the essential characteristics of the instance and may define other characteristics, and the body string b defines other characteristics of the instance. In the case where the template language is XML, the instance definition pattern is recognized by encountering one of the node names reserved by PerXML (“PerXML:extension”, “PerXML:remote”, “PerXML:repository”, “PerXML:script”, “PerXML:sql”, “PerXML:str”, or “PerXML:xml”). The configuration is obtained from the name and value information associated with the attributes of the node, the body is the contents of the node, and the object type is the reserved node name.

The PerXML Transformation Engine applies the following transformation to the current state St=(C, t, F, sl, V, A) to produce IDP(St):

1. Compute in=conf(“id” ) and I={inst: (in, inst)E V }.

2. Compute inst=(ot, conf, b, (0, { }), 0, 0.

3. Compute (Ch.n, Ch.f)=Ch(t, t+p).

4. Compute e=1 if C(“echo”)=‘true’, 0 otherwise.

5. IDP(st)=(C, Ch.f(e), F, sl, V−{(in, i):i ε I}∪{(in, inst)}, A ∪ {str:

(“apply”, str) εconf }).

### An Instance of Application Processing

When the PerXML Transformation Engine recognizes an instance application pattern p, it produces an apply element tuple (t, b) ε Name×Str. The tag name t is used to identify the instances that apply to the pattern, and the body string b represents the portion of the template to be replicated based on the values the applicable instances can assume. In the case where the template language is XML, the PerXML Transformation Engine detects an instance application pattern by checking the node name of each element node in the template; if the apply tag set of the current state includes the node name, the element is recognized as an instance application pattern, the node name is the tag name, and the element content (including the start and end tags) becomes the body string.

The PerXML Transformation Engine applies the following transformation to the current state St=(St. C, St.t, St.F, St.sl, St. V, St.A) to produce IAP(St):

1. Compute AV={(n, (cn, C, av.b, (val.n, val.f), sc, ic)) εSt.V : C(“apply” ) =t, sc=0 } and NAV=St.V -AV.

2. Compute CSt=(St.C, St.t, St.F, St.sl +1, CSt.V=NAV ∪{ (n, (cn, C, av.b, [vg(cn)](St.C ∪C, av.b), St.sl+1, 0):(n, (cn, C, av.b, (val.n, val.f), SC, iC)) ε AV }, CSt.A=St.A−t)

3. Compute CAV={(n, (cn, C, cav.b, (val.n, val.f), sc, ic+1)): (n, (cn, C, av.b, (val.n, val.f), sc, ic)) ε CSt.V, (n, inst) ε AV } and determine whether any cav=(cav.n, (cav.cn, cav.C, cav.b, (cav.val.n, cav.val.f), cav.sc, cav.ic)) ε CAV has cav.ic <=cav.val.n. Then:

a. If so, obtain a new value of CSt by configuring the PerXML Transformation Engine with an initial state of CSt and processing the template b and repeat this step

b. If not, IAP(St)=(CSt.C, CSt.t, CSt.F, St.sl, NAV ∪{ (n, (av.cn, cav.C, av.b, cav.val, 0, 0)):(n, (cav.cn, cav.C, cav.b, cav.val, cav.sc, cav.ic)) ε CAV, (n, (av.cn, av.C, av.b, av.val, av.sc, av.ic)) ε AV}, CSt.A u{t})

### Substitution Processing

When the PerXML Transformation Engine recognizes a substitution pattern p, it produces either an accessor tuple (in, args) ε Name×Args or a method tuple (in, mn, args) ε Name×Name×Args. In each case, the instance name in represents the name of the instance used to generate the substitution, and the argument list args represents the arguments to be passed to the operation associated with the instance. The method name mn, when present, provides further specification of the operation. In the case where the template language is XML, the PerXML Transformation Engine recognizes the beginning of a substitution pattern by checking for a specific substitution character; this character is the result of C(“substitutionchar”) from the current transformation engine state (C, t, F, sl, V, A). The substitution pattern must parse as a valid XML document fragment, i.e., can only appear in a place in the document where the text of the template conforms to the XML grammar before the substitution. If text from the substitution character onward can be recognized as a substitution string satisfying the PerXML substitution grammar, the text is recognized as a substitution pattern, and the instance name, method name and argument list extracted from the substitution pattern are used to define an appropriate tuple.

The PerXML Transformation Engine applies the following transformation to the current state St=(C, t, F, sl, V, A) to produce SP(St):

1. If {(in, inst): (in, inst) ε V } is empty, then SP(C, t, F, sl, V, A)=(C, t+p, F, sl, V, A).

2. For an accessor tuple (in, args) with V(in)=(cn, in.C, (val.n, val.f), sc, ic), SP(C, t, F, sl, V, A)=(C, t+[a(cn)](args, in.C, val.f(ic)), F, sl, V, A).

3. For a method tuple (in, mn, args) with V(in)=(cn, C, (val.n, val.f), sc, ic), SP(C, t, F, sl, V, A)=(C, t+[m(cn, mn)](args, in.C, val.f(ic)), F, sl, V, A).

### Configuration Setting Processing

When the PerXML Transformation Engine recognizes a configuration setting pattern p, it produces a configuration tuple (n, v) ε Name×Str. The attribute name is used to identify a configuration element, and the string value gives the value to set the configuration element to. In the case where the template language is XML, the PerXML Transformation Engine detects a configuration setting pattern by finding a processing instruction with a target of PerXML. If the remainder of the processing instruction can be expressed as name=“value”, the attribute name is the name portion of the pattern, and the string value is the value portion of the pattern.

The PerXML Transformation Engine applies the following transformation to the current state St=(C, t, F, sl, V, A) to produce CSP(St):

4. Compute C′=C−{(C.n, C.str):(C.n, C.str) e C, C.n=n }∪(n, v).

5. Compute (Ch.n, Ch.f)=Ch(t, t+p).

6. Compute e=1 if C′(“echo”)=‘true’, e=0 otherwise.

7. CSP(C, t, F, sl, V, A)=(C′, Ch.f(e), F, sl, V, A).

### Container Operation

The PerXML Standalone Program is invoked in an environment that includes:

A working directory providing a reference point for locating files (provided by the operating system);

A template filename (the first argument on a command line invocation);

An output filename (the second argument on a command line invocation);

zero or more form variable lists (any argument after the second that begins “−f”);

an optional log file name (the last argument after the second that begins “−1”);

an optional decoding transformation selector (the last argument after the second that begins “−d”);

an optional input filename (the last argument after the second that begins “−i”);

an optional repetition count string (the last argument after the second that begins “−c”);

an optional remote input source (the last argument after the second that begins (“−r).

Operating the PerXML Standalone Program:

1. Establish the Configuration

2. Process the Template

Establish the Configuration:

1. If a file “exeperxml.xml” is found in the working directory, the configuration settings defined in that file establish the initial configuration.

2. If a file “exeperxml.xml” is found in the parent directory of the working directory, the configuration settings defined in that file establish the initial configuration

3. If any form variable lists are present, the form variable lists are decomposed into form variable settings, which are combined to create the value of the form map configuration variable.

4. If a log file name is present, it becomes the value of the log file name configuration variable.

5. If a remote input source is present, use “Establish a Remote Input Source” to finish configuration; otherwise, use “Establish a File Input Source” to finish configuration.

Establish a Remote Input Source:

1. Use the remote input source as a URL. If the URL does not contain a fragment identifier, or the input filename is not present, perform an HTTP GET on the URL. Otherwise, perform an HTTP POST of the text (as opposed to the content) of the input filename to the URL. The returned content is the template.

Establish a File Input Source:

1. If an input filename is present, the contents (as opposed to the text) of the file referenced by the input filename are used as the value of the input configuration variable.

2. The contents of the template file are the template.

### Process the Template

1. Pass the template to the PerXML Transformation Engine.

2. If the decoding transformation selector is present, replace all XML character entities in the output with their single-character representation.

1. Place the output of the PerXML Transformation Engine in the output file.

Although the present invention has been described in terms of a particular embodiment, it is not intended that the invention be limited to this embodiment. Modifications within the spirit of the invention will be apparent to those skilled in the art. For example, while XML-based information description and transformation have been described, the techniques of the present invention are applicable to many different types of structured documents.

The foregoing description, for purposes of explanation, used specific nomenclature to provide a thorough understanding of the invention. However, it will be apparent to one skilled in the art that the specific details are not required in order to practice the invention. The foregoing descriptions of specific embodiments of the present invention are presented for purpose of illustration and description. They are not intended to be exhaustive or to limit the invention to the precise forms disclosed.

Obviously many modifications and variations are possible in view of the above teachings. The embodiments are shown and described in order to best explain the principles of the invention and its practical applications, to thereby enable others skilled in the art to best utilize the invention and various embodiments with various modifications as are suited to the particular use contemplated. It is intended that the scope of the invention be defined by the following claims and their equivalents:

1. A method for representing information within a structured document, the method comprising:
identifying the location and structure of the information to be represented; and
inserting a declarative representation of the identified location and structure of the information into the structured document.

2. A method for transforming information represented declaratively in a structured document, the method comprising:
receiving an indication of a particular portion of the information to transform;
receiving an indication of a target representational form for the particular portion of the information;
using the declarative representation of the information in the structured document to extract the particular portion of the information a location; and
transforming the extracted portion of the information into the target representational form.
